(19) United States
(12) Patent Application Publication
(10) Pub. No.: US 2022/0285850 A1
(43) Pub. Date: Sep. 8, 2022

(54) GROUNDING MEMBER SLOT ANTENNAS

(71) Applicant: Hewlett-Packard Development Company, L.P., Spring, TX (US)

(72) Inventors: Chin-Hung Ma, Taipei City (TW); Tsai-Yun Chuang, Taipei City (TW); Ju-Hung Chen, Taipei City (TW)

(73) Assignee: Hewlett-Packard Development Company, L.P., Spring, TX (US)

(21) Appl. No.: 17/633,240

(22) PCT Filed: Oct. 11, 2019
(86) PCT No.: PCT/US2019/055776

§ 371 Date: Feb. 7, 2022

(51) Int. Cl. H01Q 13/10; H01Q 1/48

(52) U.S. Cl. CPC H01Q 13/10; H01Q 1/48; H01Q 1/2266

(57) ABSTRACT

Example electronic devices are disclosed. In an example, the electronic device includes a housing and an antenna disposed within the housing. The antenna includes a conductive element to send and receive signals in a first frequency band, and a grounding member coupled to the conductive element and comprising a slot. The grounding member is to send and receive signals in a second frequency band.

### BACKGROUND

Electronic devices may include an antenna that facilitates communication with a wireless network. Wireless networks may include local wireless networks (e.g., wireless local area networks—WLAN) such as, for instance, WIFI networks at a home or office, or large or regional networks (e.g., wireless wide area networks—WWAN) such as, for instance, telecommunication networks. In some instances, an antenna may comprise slot(s) that determine resonant, operating frequencies with which the antenna transmits and receives wireless signal(s).

### BRIEF DESCRIPTION OF THE DRAWINGS

Various examples will be described below referring to the following figures:

FIG. 1 is a perspective view of an electronic device including slot antennas according to some examples;

FIG. 2 is a schematic view of the antennas of the electronic device of FIG. 1 according to some examples;

FIG. 3 is a cross-sectional view taken along section A-A in FIG. 2 according to some examples;

FIG. 4 is another cross-sectional view taken along section A-A in FIG. 2 according to some examples; and

FIG. 5 is another schematic view of an antenna of the electronic device of FIG. 1 according to some examples.

### DETAILED DESCRIPTION

In the figures, certain features and components disclosed herein may be shown exaggerated in scale or in somewhat schematic form, and some details of certain elements may not be shown in the interest of clarity and conciseness. In some of the figures, in order to improve clarity and conciseness, a component or an aspect of a component may be omitted.

In the following discussion and in the claims, the terms “including” and “comprising” are used in an open-ended fashion, and thus should be interpreted to mean “including, but not limited to . . . .” Also, the term “couple” or “couples” is intended to be broad enough to encompass both indirect and direct connections. Thus, if a first device couples to a second device, that connection may be through a direct connection or through an indirect connection via other devices, components, and connections. In addition, as used herein, the terms “axial” and “axially” generally refer to positions along or parallel to a central or longitudinal axis (e.g., central axis of a body or a port), while the terms “lateral” and “laterally” generally refer to positions located or spaced to the side of the central or longitudinal axis.

As used herein, including in the claims, the word “or” is used in an inclusive manner. For example, “A or B” means any of the following: “A” alone, “B” alone, or both “A” and “B.” In addition, when used herein including the claims, the word “generally” or “substantially” means within a range of plus or minus 10% of the stated value. As used herein, the term “electronic device,” refers to a device that is to carry out machine readable instructions, and may include internal components, such as, processors, power sources, memory devices, etc.

As previously described above, electronic devices may comprise an antenna (e.g., such as a slot antenna) that facilitates communication with a wireless network (e.g., WLAN, WWAN, etc.). In addition, an electronic device may communicate with a number of different networks (e.g., telecommunication networks, WIFI networks, etc.) having different operating frequencies. Thus, one may wish for the antenna(s) within a given electronic device to communicate across a number of different operating frequencies. However, the available space within an electronic housing may be limited so that it may be difficult to provide an antenna design that physically fits within the electronic device housing while also communicating across a wide range of operating frequencies. Accordingly, examples disclosed herein include slot antennas for electronic devices that may have a slot formed in a grounding member thereof so as to allow the grounding member to send and receive signals within an additional operating frequency for the antenna without increasing an overall size or footprint thereof.

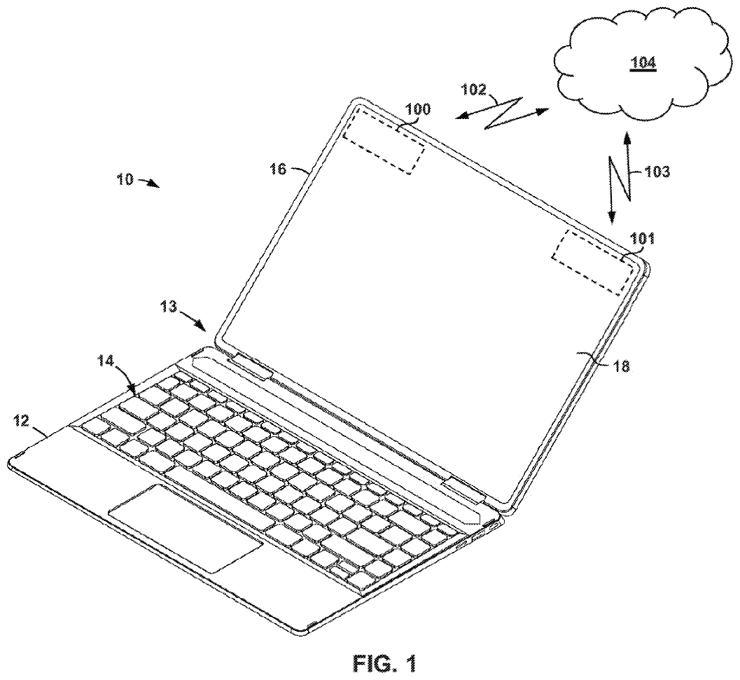

Referring now to FIG. 1, an electronic device 10 according to some examples is shown. In this example, electronic device 10 is a laptop computer that includes a first housing member 12 rotatably coupled to a second housing member 16 at a hinge 13. The first housing member 12 includes a user input device, such as, for example, a keyboard 14. The second housing member 16 includes a display panel 18 (e.g., a liquid crystal display (LCD) panel, a plasma display panel, organic light emitting diode (OLED) display panel, etc.) that is to project images for viewing by a user (not shown) of the electronic device 10.

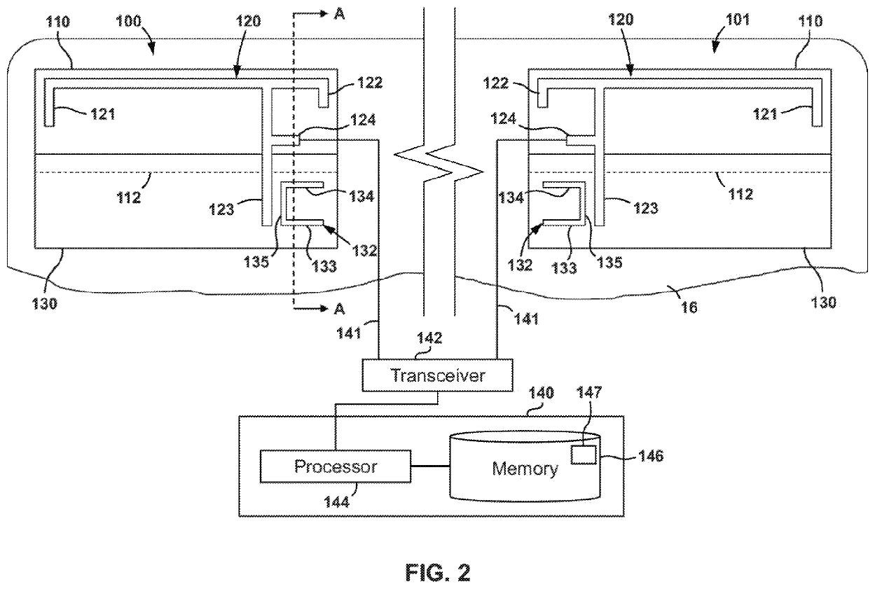

In other examples, electronic device 10 may comprise another type of electronic device (that is, other than a laptop computer as shown in FIGS. 1 and 2). For instance, in other examples, electronic device 10 may comprise any of the other electronic devices noted above (e.g., a tablet computer, smartphone, desktop computer, server, etc.).

In addition, electronic device 10 includes a first antenna 100 and a second antenna 101 that are to send and receive wireless signals 102 and 103, respectively, to and from a wireless network 104 (or a plurality of wireless networks). In some examples (e.g., such as the example of FIG. 1), the antennas 100, 101 are disposed within the second housing member 16. In particular, in some examples, the antennas 100, 101 are partially or totally disposed under the display panel 18 (or some portion or layer thereof). However, antennas 100, 101 may be placed in any suitable location within electronic device 10 (e.g., such alternative locations within second housing member 16 or within first housing member 12).

The wireless network 104 may comprise any suitable wireless network previously described above (e.g., WLAN, WWAN, etc.). During operations, antennas 100, 101 may receive wireless signals (e.g., wireless signals 102, 103) from wireless network 104, and may send wireless signals (e.g., wireless signal 102, 103) to wireless network 104. As will be described in more detail below, the antennas 100, 101 may include grounding members that have slots formed therein. The shape and arrangement of the slots in the grounding members may allow the grounding members to send and receive signals within a portion of the total operating frequency envelope of the antennas 100, 101. Accordingly, antennas 100, 101 may provide electronic device 10 with additional wireless signal operating frequencies without increasing an overall size of footprint thereof within the second housing member 16. Additional details of examples of antennas 100, 101 are now described below.

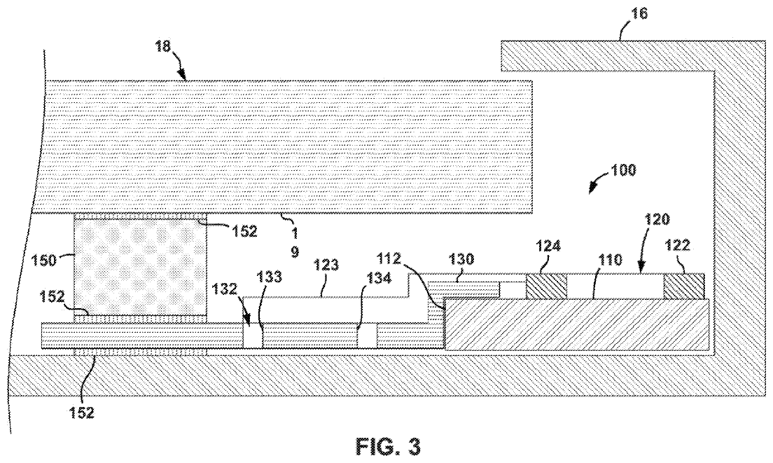

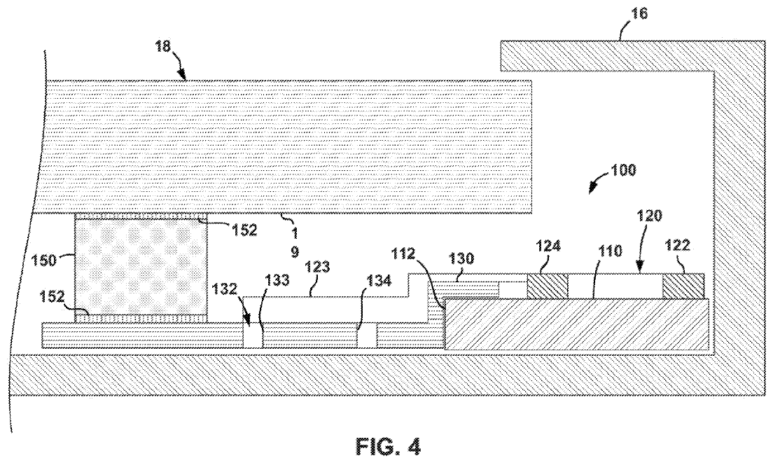

Referring now to FIG. 2, antennas 100, 101 are shown installed within second housing member 16. For convenience, and so as to better show the features of antennas 100, 101, display panel 18 (see e.g., FIG. 1) is not shown in FIG. 2; however, it should be appreciated that display panel 18 (or some portion thereof) may be positioned over the top of some or all of the antennas 100, 101 when electronic device 10 is fully assembled (note: display panel 18 is shown in the cross-sectional views of FIGS. 3 and 4 which are discussed below).

Referring now to FIGS. 2 and 3, first antenna 100 includes a substrate 110, a grounding member 130 coupled to the substrate 110, and a conductive element 120 coupled to both the substrate 110 and the grounding member 130. The substrate 110 may comprise a printed circuit board (PCB) or any other suitable substrate. In some examples, some or all of the substrate 110 may comprise a dielectric material. The grounding member 130 may comprise a sheet or layer of electrically conductive material. For instance, in some examples, the grounding member 130 comprises a sheet or layer of conductive foil (e.g., such as copper foil). In the example of FIGS. 2 and 3 the grounding member 130 is partially overlapped on the substrate 110 such that the grounding member 130 covers an edge 112 of the substrate 110.

Conductive element 120 is disposed on top of the substrate 110 and the grounding member 130. Conductive element 120 may comprise an electrically conductive material, such as, for instance, a metallic material (e.g., copper, silver, platinum, gold, aluminum, etc.). In addition, conductive element 120 is shaped and designed so as to produce electromagnetic waves having certain desired characteristics (e.g., wave length, amplitude, frequency, etc.) when energized with electric current. In particular, conductive element 120 comprises a first portion 121, a second portion 122, and a third portion 123. The first portion 121 may be shaped, sized, and arranged to send and receive electromagnetic signals in a first frequency band, and the second portion 122 may be shaped, sized, and arranged to send and receive electromagnetic signals in a second frequency band that is different (e.g., higher or lower) than the first frequency band. For instance, in some examples, the first frequency band may be lower than the second frequency band.

The third portion 123 of conductive element 120 is disposed on top of the grounding member 130 so that electric current is conducted between the grounding member 130 and the conductive element 120 to the third portion 123. A slot 132 is formed in the grounding member 130. As best shown in FIG. 3, the slot 132 extends completely through the grounding member 130 so as to form an opening or aperture therethrough. During operations, electric current may be conducted into the grounding member 130 via the third portion 123 of the conductive element 120. The electric current may then conduct around the edges of the slot 132 so as to produce and/or receive electromagnetic waves that are in a third frequency band that is different from the first and second frequency bands of the first and second portions 121 and 122, respectively, of the conductive element 120. In some examples, the third frequency band may be higher or greater than both the first frequency band and the second frequency band. Accordingly, the first frequency band and the second frequency band of the first portion 121 and the second portion 122, respectively, may correspond with a low frequency band (e.g., from about 600 MHz to about 1200 MHz) and a high frequency band (e.g., from about 1700 MHz to about 2700 MHz) of the first antenna 100, and the third frequency band of the slot 132 may correspond with an ultra-high frequency band (e.g., from about 3 GHz to about 5 GHz) for the first antenna 100.

Thus, the size and shape of the slot 132 may be chosen so as to allow the grounding member to send and receive electromagnetic signals in a particular frequency band (e.g., the third frequency band described above). In the example of FIGS. 2 and 3, slot 132 is substantially C-shaped. In particular, slot 132 includes a first segment 133 and a second segment 134 extending parallel to one another. In addition, slot 132 includes a third segment 135 extending between the first segment 133 and the second segment 134.

Referring specifically to FIG. 3, grounding member 130 may be electrically coupled to a conductive surface (or a plurality of conductive surfaces) within the second housing member 16. For instance, in the example of FIG. 3, the housing 16 is constructed (e.g., partially or wholly) from a conductive material (e.g., a metallic material), and thus, the grounding member 130 may be electrically coupled to a conductive surface of the second housing member 16 via a conductive bonding material 152 (e.g., such as conductive tape). In addition, grounding member 130 is also electrically coupled to a conductive surface 19 of the display panel 18. In particular, an electrically conductive gasket 150 (e.g., comprising an electrically conductive elastomer in some examples) may be placed between the grounding member 130 and the conductive surface 19 via layers of conductive bonding material 152 (e.g., conductive tape). The conductive surface 19 may comprise a surface of any electrically conductive component or layer of display panel 18 (e.g., including a grounding layer of the display panel 18).

Referring briefly to FIG. 4, in some examples, the grounding member 130 may not be electrically coupled to a conductive surface of the second housing member 16. For instance, in some examples, the second housing member 16 may comprise (e.g., partially or wholly) a dielectric material (e.g., such as a polymer). Thus, in these examples, the grounding member 130 may be electrically coupled to conductive surface 19 in the manner described above (e.g., via conductive gasket 150 and conductive tape 152, etc.), but is not electrically coupled to a surface of the second housing member 16.

It should be appreciated that the particular conductive surfaces described above are merely examples of conductive surfaces within the electronic device 10 that may be electrically coupled to the grounding member 130. Thus, these examples should not be interpreted as limiting the possible conductive surfaces that may be electrically coupled to grounding member 130 in other examples.

Referring again to FIG. 2, second antenna 101 may generally include the same components as first antenna 100—namely a substrate 110, a conductive element 120, a grounding member 130 (including a corresponding slot 132 formed therein). Thus, the same reference numerals are utilized for components of second antenna 101 that are shared with first antenna 100, and the description of these components within second antenna 101 is not repeated in the interests of brevity.

Referring now to FIGS. 1 and 2, during operations, the conductive elements 120 and grounding members 130 (e.g., via slots 132) of antennas 100, 101 may send and receive electromagnetic signals in the first, second, and third frequency bands as previously described above. However, the electromagnetic signals that are sent and received by first antenna 100 (e.g., signals 102) may include attributes, characteristics, and/or features that do not correlate with the corresponding attributes, characteristics, and/or features of the electromagnetic signals that are sent and received by second antenna 101 (e.g., signals 103). In particular, the electromagnetic signals 102 of the first antenna 100 may have a low (or substantially zero) Envelope Correlation Coefficient (ECC) with the electromagnetic signals 103 of the second antenna 101. As used herein, the ECC is a measure or indication of how correlated two electromagnetic signals are. Thus, a higher number would indicate that two electromagnetic signals are more closely correlated so that an antenna may send and receive both signals during operations. However, a lower number (e.g., including zero) would indicate little or no correlation so that the chances of interference (e.g., at a given antenna) between the two signals is reduced (or eliminated).

In this example, the electromagnetic signals 102 sent and received by the first antenna 100 (including the electromagnetic waves produced and received by the first portion 121, the second portion 122, and the slot 132 of first antenna 100) may be left hand circular polarized signals, and the electromagnetic signals 103 sent and received by the second antenna 101 (including the electromagnetic waves produced and received by the first portion 121, the second portion 122, and the slot 132 of second antenna 101) may be right hand circular polarized signals. As used herein, a circular polarized signal comprises an electromagnetic wave wherein each point in the electric field of the wave has a constant magnitude, however, the direction of adjacent electric field points rotate at a constant rate about an axis of travel of the electromagnetic wave. Thus, a “left hand circular polarized signal” may include electric field points that rotate in a first direction about the axis of travel, and a “right hand circular polarized signal” may include electric field points that rotate in a second direction about the axis of travel that is opposite the first direction. The left and right directions for the above described circular polarized signals may be assessed or determined based on the direction the electromagnetic wave (or signal) is moving along the axis of travel. As a result, because of the opposite rotation of the electromagnetic signals 102, 103 of antennas 100, 101, the signals 102, 103 may have a low or substantially zero ECC. Accordingly, there may be little or no interference or cross-talk between the antennas 100, 101 during operations.

Referring still to FIG. 2, conductive elements 120 of antennas 100, 101 are electrically coupled to a transceiver 142, which is also coupled to a controller (or control assembly) 140 at corresponding terminals 124. Controller 140 may be a dedicated controller for first antenna 100 and/or second antenna 101 or may be included within a main controller or control assembly for electronic device 10 (see e.g., FIG. 1). Controller 140 generally includes a processor 144 and a memory 146, which in some examples comprises a non-transitory machine-readable medium.

The processor 144 (e.g., microprocessor, central processing unit, or collection of such processor devices, etc.) executes machine-readable instructions 147 stored in memory 146, and upon executing the machine-readable instructions 147 on memory 146, performs some or all of the actions attributed herein to the processor 144, the controller 140, and/or more generally to the electronic device 10. The memory 146 may comprise volatile storage (e.g., random access memory (RAM)), non-volatile storage (e.g., flash memory, read-only memory (ROM)), or combinations of both volatile and non-volatile storage. Transceiver 142 is coupled to the processor 144 and is to receive and transmit signals (e.g., control signals, etc.) to and from processor 144 as well as to and from antennas 100, 101. Controller 140 is coupled to transceiver 142 and transceiver is additionally coupled to antennas 100, 101 particularly to conductive elements 120 of antennas 100, 101) by conductive paths 141.

Referring now to FIGS. 1 and 2, during operations, signals are generated by processor 144, processed by transceiver 142, and sent to antenna 100 and/or antenna 101 via conductive paths 141. The conductive element(s) 120 and the grounding member(s) 130 of antenna 100 and/or antenna 101 may receive the signals and generate a corresponding electromagnetic wave (or plurality of electromagnetic waves). In addition, during operations, signals are received by the conductive element(s) 120 and the grounding member(s) 130 of antenna 100 and/or antenna 101 that are then communicated to controller 140 via conductive paths 141 and transceiver 142.

During these operations, the first and second portions 121, 122 of conductive elements 120 for antennas 100, 101 may send and/or receive electromagnetic signals in the first and second frequency bands as previously described above. In addition, the grounding members 130 of the antennas 100, 101 may also send and/or receive electromagnetic signals in the third frequency band via the slots 132 as previously described above. Thus, the antennas 100, 101 may provide a plurality of frequency bands for communication with a wireless network 104 (or plurality of wireless networks). In addition, because the third frequency band is provided via the slot 132 in grounding members 130, the size and length of the conductive elements 120 of antennas 100, 101 may be generally reduced (while still providing operating frequencies in the third frequency band) so that an overall footprint or size of the antennas 100, 101 may be reduced.

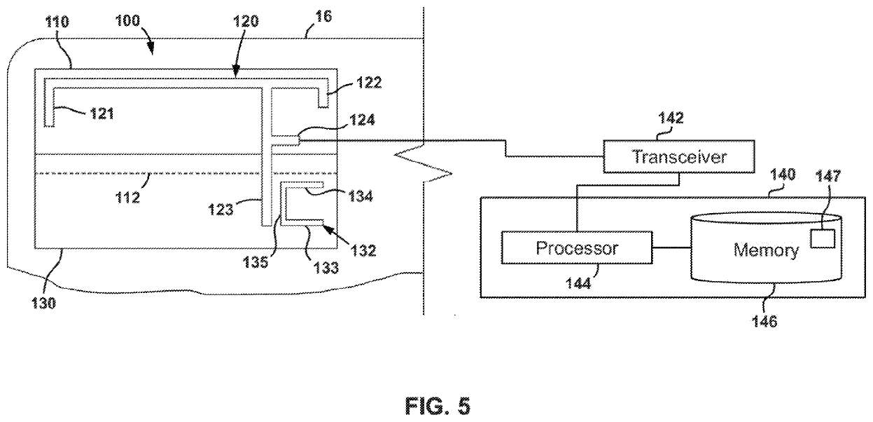

Referring now to FIGS. 1 and 5, while the electronic device 10 of FIG. 1 is shown to include a pair of antennas 100, 101, in other examples, a single antenna may be included therein. For instance, in the example of FIG. 5, first antenna 100 is disposed within second housing member 16 in the manner described above; however, second antenna 101 is not included. Thus, during operations, first antenna 100 may send and/or receive electromagnetic signals that are communicated from and/or to, respectively, the controller 140 via transceiver 142 in the same manner described above. However, no additional signals are sent and/or received to and/or from, respectively, the second antenna 101 (which is omitted in this example). It should be appreciated that other examples of electronic device 10 may include more than two antennas (e.g., antennas 100, 101, and/or other antenna types or designs, etc.).

Examples disclosed herein include slot antennas for electronic devices (e.g., antennas 100, 101) that may have a slot (e.g., slots 132) formed in a grounding member (e.g., grounding members 130) thereof so as to allow the grounding member to send and receive signals within an additional operating frequency for the antenna. As a result, through use of the described antennas, additional operational frequencies may be added without increasing a size and/or length of a conductive member of the antenna, so that the size of such antennas may be reduced.

The above discussion is meant to be illustrative of the principles and various examples of the present disclosure. Numerous variations and modifications will become apparent to those skilled in the art once the above disclosure is fully appreciated. It is intended that the following claims be interpreted to embrace all such variations and modifications.

What is claimed is:

1. An electronic device, comprising:
a housing; and
an antenna disposed within the housing, wherein the antenna comprises:
a conductive element to send and receive signals in a first frequency band; and
a grounding member coupled to the conductive element and comprising a slot, wherein the grounding member is to send and receive signals in a second frequency band.

2. The electronic device of claim 1, wherein the grounding member is electrically coupled to a conductive surface within the housing.

3. The electronic device of claim 2, wherein the conductive surface forms a portion of the housing.

4. The electronic device of claim 2, comprising a display panel, wherein the conductive surface forms a portion of the display panel.

5. The electronic device of claim 1, wherein the grounding member comprises a layer of conductive foil.

6. The electronic device of claim 1, comprising:
a second antenna disposed within the housing, wherein the second antenna comprises:
a second conductive element to send and receive signals in the first frequency band;
a second grounding member electrically coupled to the second conductive element and comprising a second slot, wherein the second grounding member is to send and receive signals in the second frequency band;
wherein the antenna is to send and receive left hand circular polarized signals and the second antenna is to send and receive right hand circular polarized signals.

7. An electronic device comprising:
a housing; and
a first antenna disposed within the housing, wherein the first antenna comprises:
a substrate;
a grounding member having a slot formed therein; and
a conductive element having first and second portions positioned on the substrate and a third portion coupling the first and second portions to the grounding member,
wherein the first portion of the conductive element is to send and receive signals in a first frequency band and the second portion of the conductive element is to send and receive signals in a second frequency band that is higher than the first frequency band, and
wherein the slot is shaped such that the grounding member is to send and receive wireless signals in a third frequency band that is higher than the first and second frequency bands.

8. The electronic device of claim 7, comprising a second antenna disposed within the housing, wherein the second antenna comprises:
a second substrate;
a second grounding member having a second slot formed therein; and
a second conductive element mounted to the second substrate and electrically coupled to the second grounding member, wherein the second conductive element is to send and receive wireless signals in the first and second frequency bands;
wherein the second slot is shaped such that the second grounding member is to send and receive wireless signals in the third frequency band; and
wherein the grounding member of the first antenna and the second grounding member of the second antenna are disposed below a display panel of the electronic device.

9. The electronic device of claim 8, wherein the first antenna is to send and receive left hand circular polarized signals and the second antenna is to send and receive right hand circular polarized signals.

10. The electronic device of claim 7, wherein the grounding member of the first antenna is electrically coupled to a conductive surface within the housing.

11. The electronic device of claim 10, wherein the conductive surface forms a portion of the housing.

12. The electronic device of claim 10, comprising a display panel, wherein the conductive surface forms a portion of the display panel.

13. An electronic device comprising:
a housing;
a first antenna disposed within the housing, wherein the first antenna is to send and receive left hand circular polarized signals; and
a second antenna disposed within the housing, wherein the second antenna is to send and receive right hand circular polarized signals;
wherein the first antenna and the second antenna each comprise:
a substrate;
a conductive element disposed on the substrate, wherein the antenna is to send and receive signals in first and second frequency bands; and
a grounding member electrically coupled to the conductive element and comprising a slot, wherein the grounding member is to send and receive signals in a third frequency band.

14. The electronic device of claim 13, wherein the third frequency band is higher than the first and second frequency bands.

15. The electronic device of claim 13, comprising:
a display panel;
wherein the housing comprises a first housing member pivotably coupled to a second housing member, wherein the display panel is supported by the second housing member; and
wherein the grounding member of the first antenna and the grounding member of the second antenna are disposed under the display panel within the second housing member.
